(19) United States
(12) Patent Application Publication
(10) Pub. No.: US 2006/0218593 A1
(43) Pub. Date: Sep. 28, 2006

(54) Digital coaxial cable LAN

(76) Inventors: Amir S. Afshary, Chandler, AZ (US); Desikan Iyadurai, Phoenix, AZ (US); Brian R. Mears, Tempe, AZ (US); Gregory B. Tucker, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/325,093

(22) Filed: Jan. 3, 2006

Related U.S. Application Data
(63) Continuation of application No. 09/164,427, filed on Sep. 30, 1998.

(51) Int. Cl. H04N 7/18

(52) U.S. Cl. 725/74; 725/78

(57) ABSTRACT

The invention relates to a coaxial cable local area network (LAN) for digitally communicating client generated data between clients of the cable LAN. The cable LAN has adapters in communication with both the clients and other adapters of the cable LAN. Connected through coaxial cable, these adapters generate and communicate data transmitting signals that take advantage of the operating frequency spectrum of the coaxial cable so as to not interfere with the operating frequency of the client data within the coaxial cable. Other features are disclosed.

### BACKGROUND OF THE INVENTION

1. Field of the Invention

The invention relates generally to networking and more particularly to data distribution through a coaxial cable at frequencies that take advantage of the operating frequency spectrum of the coaxial cable so as to not interfere with the operating frequency of the client data within the coaxial cable.

2. Background Information

Conventional homes contain many electronic devices that generate data or operate on data received internally, from other devices, or from sources outside of the home. For example, content devices such as televisions, video cassette recorders, personal computers, and stereos as well as monitor and control devices such as climate-control devices, security devices, and home automation devices all generate or use data. In-home local area networks (LANs) may be used to distribute such data around the home, both to and from these devices.

As home based LANs become more popular for in-home networking, the ability to transmit high-bandwidth data including digital video remains difficult to implement. Several alternative mediums for in-home networking are known. For example, current solutions that do not require new wiring include AC power lines, telephone lines, and wireless communication. There are also options that require installing new wires such as CAT-5 twisted pair, fiber optic, and IEEE 1394 (fire-wire). In general, the solutions that do not require new wires suffer from low bandwidth or high cost. Solutions that require new wires suffer from being expensive as well as technology that has not been proven over time as compared to coaxial cables. Table I lists some of these alternative mediums with their limitations.

TABLE 1
Alternative Mediums

| MEDIUM | LIMITATIONS |
|---|---|
| AC power-lines | Unregulated |
| | Low bit-rate (Harsh environment) |
| | Data security issues |
| | Perceived usage hazards |
| Telephone lines | RF interference |
| | RF emissions regulations |
| Wireless | Limited bandwidth |
| | Expensive |
| | Data security issues |
| | Transmission disruption due to |
| | movement |
| New wires | Installation costs |
| | Maintenance costs |

Thus, there is a need to transmit data around the home and elsewhere in cost-effective, quick, and secure fashion.

### SUMMARY OF THE INVENTION

The invention relates to a coaxial cable local area network (LAN) for digitally communicating client generated data between clients of the cable LAN. The cable LAN has adapters in communication with both the clients and other adapters of the cable LAN. Connected through coaxial cable, these adapters generate and communicate data transmitting signals that take advantage of the operating frequency spectrum of the coaxial cable so as to not interfere with the operating frequency of the client data within the coaxial cable. Other features are disclosed.

### BRIEF DESCRIPTION OF THE DRAWINGS

FIG. 1 is an illustration of an in-home coaxial cable LAN in accordance with an embodiment of the invention.

FIG. 2 is a schematic illustration of a coaxial cable LAN in accordance with an embodiment of the invention.

FIG. 3 illustrates an operating frequency of the client data and the adapter signal in accordance with an embodiment of the invention.

FIG. 4 is a schematic of an architecture of a cable LAN adapter in accordance with an embodiment of the invention.

### DETAILED DESCRIPTION OF THE INVENTION

The invention discloses a coaxial cable local area network (LAN) for communicating data between clients of the cable LAN. The benefits of the cable LAN is the ability transmit data in cost-effective, secure fashion, without interfering with cable service company operations.

For purposes of explanation, specific embodiments are set forth to provide a thorough understanding of the present invention. However, it will be understood by one skilled in the art, from reading this disclosure, that the invention may be practiced without these details. Moreover, well-known elements, devices, process steps and the like are not set forth in detail in order to avoid obscuring the present invention.

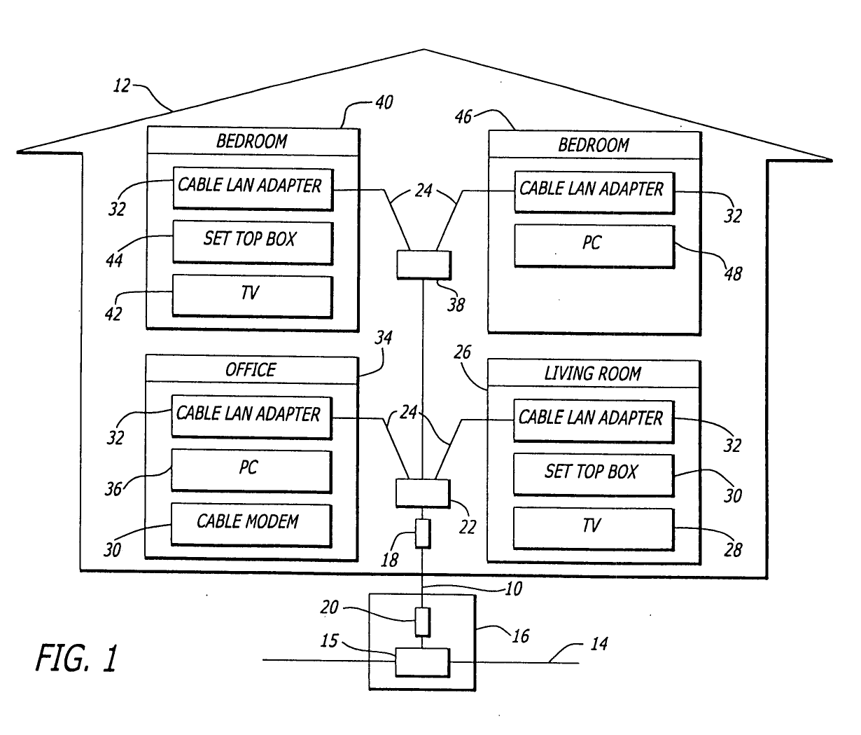

Reference is now made to FIGS. 1 through 4 to illustrate the embodiments of the invention. FIG. 1 is an illustration of an in-home coaxial cable LAN. As shown, drop cable 10 enters home 12 after it is tapped off main trunk 14 through cable service company splitter 15 within distribution box 16. Near the point at which drop cable 10 enters home 12, low pass filter (LPF) 18 is installed by the user, upstream of the in-home cable LAN network and downstream of any cable service company supplied low pass filter 20.

A cable LAN isolator such as LPF 18 preferably is installed by the user downstream of cable service company splitter 15, even when a low pass filter is provided by the cable service company as shown by low pass filter 20 in FIG. 1. The need for such a device can be attributed to several operational limitations such as security, performance improvement of premise network, and legal compliance. Here, LPF 18 maintains security for the cable LAN, works to improve the performance of the cable LAN, and prevents signals generated within the cable LAN from interfering with cable service company operations.

By restricting spurious signals or cable LAN signals to the premise of the user, LPF 18 maintains security by preventing such signals from getting back to the public cable network. Although LPF 18 is shown installed within the physical premise of home 12, LPF 18 may be secured elsewhere to maintain security. For example, installing LPF 18 within a lock box external to home 12 would maintain security. LPF 18 will also reflect cable LAN transmitted signals back into the network of the cable LAN. Thus, where splitter 22 is located close to LPF 18, the return loss characteristics of LPF 18 may be helpful in coupling the cable LAN signal power from one arm of splitter 22 to another arm of splitter 22. This, in turn, would decrease the amount of power needed to transmit cable LAN signals and thus improve the performance of the invention. Moreover, by preventing signals generated within the cable LAN from interfering with cable service company signals within main trunk 14, LPF 18 serves legal compliance requirements.

Depending on the type of cable system, LPF 18 will have different cut-off frequencies. For example, one cable system only requires that the low pass filter have a cut off frequency of less than 1000 MHz whereas older cable systems require that the low pass filter have a cut off frequency of less than 450 MHz.

Coaxial cable splitters permit more than one client to receive identical data by dividing the cable into two or more cable wires. Thus, from the point at which drop cable 10 enters home 12, drop cable 10 is split by splitter 22 into different cable wires 24, each cable wire 24 being routed to different rooms in home 12. Within living room 26 of FIG. 1 is living room television (TV) 28 having set top box (STB) 30. Set top box 30 includes boxes that provide interactive television through high speed internet data access. Coupled between cable wire 24 and set top box 30 is cable LAN adapter 32. Cable wire 24 is also routed to office 34. Within office 34 is office personal computer (PC) 36 having an internet gateway. The internet gateway may be personal computer 36 having high speed access to the internet, where the high speed access may be achieved through the shown a cable modem 30, as well as other connection such as asymmetric digital subscriber loop (ADSL) modem, an integrated service digital network (ISDN), a T1 line, and a multimedia cable network system (MCNS) cable modem. Coupled between cable wire 24 and personal computer 36 is a second cable LAN adapter 32.

Cable wire 24 is also routed to bedroom 40 and to bedroom 46. To communicate with cable LAN adapter 32 in bedroom 40 and bedroom 46, cable wire 24 is further divided from splitter 22 by splitter 38 into two cable wires 24. Within bedroom 40 is bedroom TV 42 having set top box 44. Coupled between cable wire 24 and set top box 44 is a third cable LAN adapter 32. Within bedroom 46 is bedroom PC 48 coupled to a fourth cable LAN adapter 32. To complete the cable LAN network, cable wire 24 from splitter 38 is connected to cable LAN adapter 32 in bedroom 46. The number and arrangement of rooms and clients in home 12 is not particular to an embodiment of the invention. Home 12 may have different rooms, in different numbers and arrangements, each having different clients.

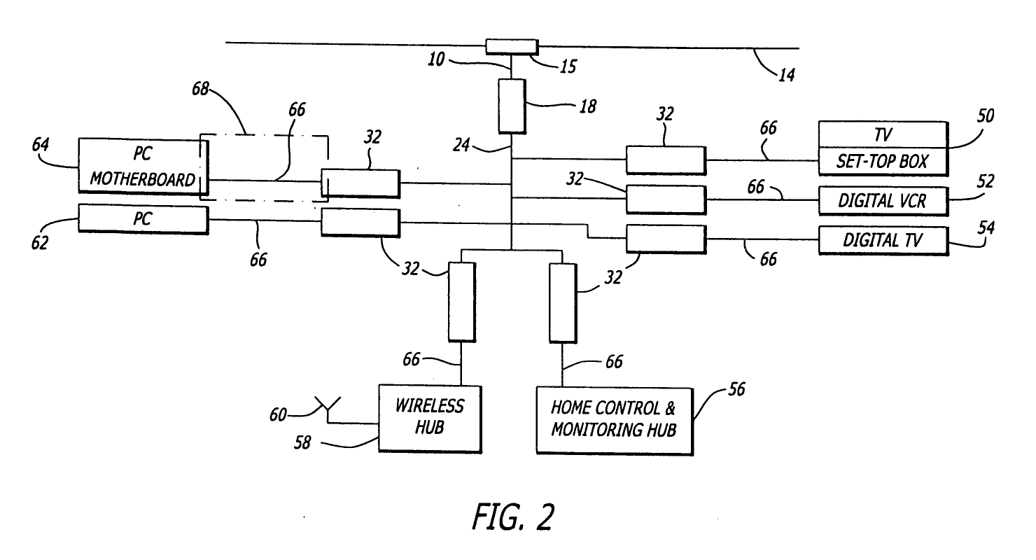

Typical clients of the cable LAN network are shown in FIG. 2. These clients may include digital TV set top box 50, digital video cassette recorder (VCR) 52, digital TV 54, home control and monitoring hub 56, wireless hub 58 with bridge 60, personal computer 62, and personal computer motherboard 64. Bridge 60 of wireless hub 58 is capable of communicating with different wireless devices. For example, one such wireless device may be a remote-control device that can be used for multiple clients on the network such as PC's, set top boxes, and digital TV's.

As shown in FIG. 2, client interface 66 couples cable LAN adapter 32 to a client. Adapter 32 serves to connect these clients to the network of cable wires 24. Client interface 66 may be any suitable computer interface, such as a Peripheral Component Interconnect (PCI) adapter card, Universal Serial Bus (USB), or buses meeting the Institute of Electronic and Electrical Engineering standard for a high performance serial bus, IEEE 1394. Adapter 32 may also be coupled to a client by other techniques. For example, adapter 32 may be housed in a client of the cable-LAN network such as indicated by dashed lines 68 for PC motherboard 64.

In the preferred embodiment, there is at least one cable wire 24 couple between a pair of adapters 32. In tests run on signal attenuation due to cable length, coaxial cable wire 24 that totaled less than 1000 feet in length operated within acceptable attenuation loss limits. Longer lengths are possible and are a function of at least the hardware and software of adapter 32.

The overall operation can be understood from FIG. 2. In the overall operation, a first client, such as PC 62, communicates digital data to a first cable LAN adapter 32 through client interface 66. After processing the data for transmission, the first cable LAN adapter 32 communicates the processed data to a second cable LAN adapter 32 through coaxial cable wire 24. On receiving the data, the second adapter 32 further processes the transmitted data to a form usable by a second client, such as digital TV 54, and transmits that data to second client digital TV 54 through client interface 66. First cable LAN adapter 32 may also communicate this same data to other adapters 32, that, in turn, may transmit the received data to their associated client.

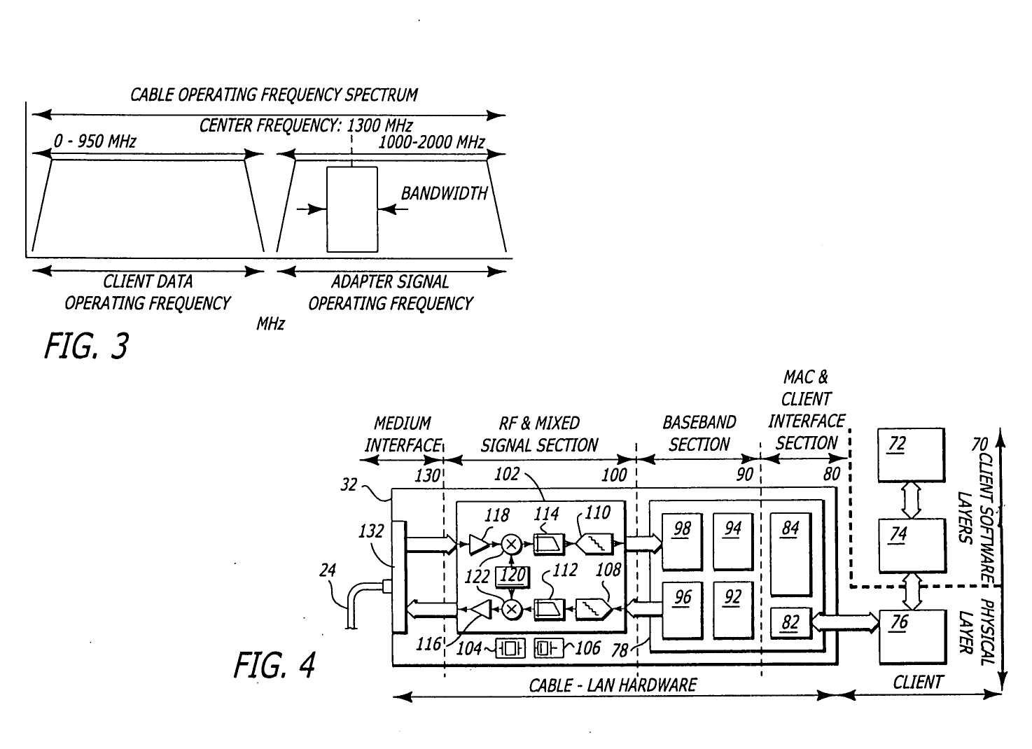

FIG. 3 illustrates an operating frequency of the client data and the adapter signal. Coaxial cables are currently being used by data suppliers to communicated data such as television and internet data to individual homes. These cables themselves are a very clear, clean medium capable of handling operating frequencies of up to 2000 MHz. However, most of this operating frequency spectrum goes unused by data suppliers since initially there was little need for frequencies higher than 450 MHz and, as need for higher operating frequencies slowly increased, costs to changing the infrastructure of the data suppliers became the prohibiting factor.

The lower region identified in FIG. 3 as 0-950 MHz is where conventional cable TV, digital cable TV, and cable modem services are offered. Where this is the case, the cable LAN signal operating frequency may be located within the higher region identified as 1000-2000 MHz at the center frequency of 1300 MHz with a bandwidth of 5 MHz. Here, the cable LAN utilizes the operating frequency spectrum not used by conventional cable services. The same is true for other forms of data such climate-control data, security data, home automation data, Moving Picture Experts Group 2 (MPEG-2) high resolution digital video data, audio data, or internet data.

In the preferred embodiment, a signal generated by adapter 32 downstream of LPF 18 rapidly transmits data from one adapter to another adapter as a carrier modulated digital signal. The carrier modulated digital signal may be generated in conjunction with using Quadrature Phase Shift Keying (QPSK) modulation typically employed on satellite technology. Since QPSK modulation operates at 2 bits per hertz, the signal speed would be 10 megabits per second (Mbps) for a 5 MHz bandwidth. Modulation is further discussed below.

A significant advantage of this invention is the large bandwidths that may be applied in transmitting data. For example, within the 1000-2000 MHz region shown in FIG. 3, bandwidths of 5 MHz, 10 MHz, 20 MHz, 50 MHz, or higher are possible. By using bandwidths larger than 5 MHz, the signal speed increases. With coaxial cabling, speeds greater than 100 Mbps can be achieved. Preferably, the signal speed will be greater than 10 Mbps when necessary to quickly distribute digital video and other types of high-bandwidth data within the home.

As depicted in FIG. 3, the signal operating frequency could be anywhere above 1000 MHz. However, Cable LAN's operating region is not limited to this. For example, in older homes that use older type coaxial cable and older type splitters, normal cable operations are maintained below 450 MHz. In this case, the signal operating frequency of the cable LAN would preferably be between 600 to 800 MHz, but need not be. Since the signal operating frequency is subject at the lower end to the client data operating frequency, the signal operating frequency could be just at the border or fringe of the rated or actual data operating frequency being utilized within the coaxial cable. Operating at the border or fringe of the data operating frequency takes advantage of the operating frequency spectrum of the coaxial cable so as to not interfere with the operating frequency of the data, thereby permitting the signal and data other than that carried by the signal to be communicated within the coaxial cable at the same time, within the same space. Being adaptable enough to operate at this periphery of the data operating frequency makes the cable LAN flexible enough to operate on any coaxial cable system, despite the different limitations such as older network components, different geographies, different service providers, and different regulations. Moreover, since the signal operating frequency is subject at the higher end only to the operating frequency spectrum of the coaxial cable, the signal bandwidth may be much greater than 5 MHz, thereby increasing the signal speed. A 100 MHz bandwidth, for example, results in a signal speed of 200 Mbps. In this way, the large operating bandwidth makes the cable LAN ideal for quickly transmitting high-resolution digital video (such as MPEG-2) and other high speed data.

FIG. 4 is a schematic of an architecture of cable LAN adapter 32. As seen in FIG. 4, client software layers 70 is comprised of cable LAN protocol layers/stacks 72 and interface software/driver stack 74. Analog or digital data from a first client is processed as necessary through that client's software layer into a digital format. This digitized data is then communicated to cable LAN adapter 32 associated with that first client for processing through the hardware sections of the cable LAN adapter. In accordance with an embodiment of the cable LAN adapter of the invention, cable LAN adapter 32 partitions into four hardware sections: I. MAC & Client Interface Section 80; II. Baseband Section 90; III. RF & Mixed Signal Section 100; and IV. Medium Interface Section 130.

I. MAC & Client Interface Section

As part of broadband application specific integrated circuit (ASIC) 78, Media Access Control (MAC) & Client Interface section 80 operates both as a burst controller and as a protocol device to coordinate events—such as when to receive the data from the client and when to transmit data to the client—between the client and Baseband section 90 of cable LAN adapter 32.

Client interface 76 is the front line communication link between adapter 32 and the particular client. Preferably, the client interface logic communicates with the client, communicates with the modulator, processes the particular data from the client and the modulator, and keeps track of time. Given the variety of clients that may occupy the cable LAN, it is important to utilize a universal client interface.

As shown in FIG. 4, the hardware of client interface 76 may be a stand alone component coupled by coaxial cable between interface (I/F) core 82 of broadband ASIC 78 and the in/out (I/O) port of the client. Such stand alone components include a Universal Serial Bus (USB) attachment or attachments meeting the Institute of Electronic and Electrical Engineering (IEEE) standard for a high performance serial bus, IEEE 1394. Client interface 76 may also be integrated into MAC & Client Interface section 80 of cable LAN adapter 32 or housed into the motherboard of a client such as a personal computer (PC) or a set top box (STB). Moreover, through an expansion card such as a Peripheral Component Interconnect (PCI) adapter card, client interface 76 may be housed internally to adapter 32 or to a client.

If data copyright protection is a concern, client interface 76 can be coupled to a dongle security system key consisting of a serialized erasable programmable read-only memory (EPROM) and some drivers in a D-25 connector shell connected to the I/O port of either adapter 32 or the client. With a dongle security system key installed, users can make as many communications or “copies” of the data as they want but must respond with the dongle's programmed validation code for each copy, thereby accounting for each copy made. To allow daisy-chained dongles, the dongles can be designed to pass data through the I/O port and to monitor for magic codes (and combinations of status lines) with little interference to devices further down the line.

Burst controller 84 of MAC & Client Interface section 80 is a time division multiple access (TDMA) scheme that supports both isochronous and asynchronous data through burst control as well as accounts for high interrupt latency on the PC. Isochronous service guarantees the reserved bandwidth while asynchronous service provides a conventional LAN type of service that is ideal for data sharing applications.

II. Baseband Section

From MAC & Client Interface section 80, the digital data is communicated to Baseband section 90 that is part of broadband ASIC 78. In Baseband section 90, the data is encoded and modulated.

To encode the data, Forward Error Correction (FEC) encoder 92 is used. Preferably, FEC encoder 92 is a Reed-Solomon Error Correction Code (R-S ECC) encoder. The advantage of using a RS ECC encoder is that the RS ECC encoder may be reused in the FEC decoder 94, thereby dramatically reducing the complexity of syndrome calculation and thus reducing processing speed burden on the syndrome block. On interacting with FEC encoder 92, parity bits (or bytes) are added to the data to permit detection of data that becomes corrupted in transit as well as permit correction of the same. Other bits that may be added include network control data that specifies the routing, content data that specifies the what is being transmitted, as well as other known parity bits.

Once through FEC encoder 92, the data encounters modulator 96. Modulator 96 remaps the digital data and presents the data in an analog wave form to permit the data to be transmitted within the coaxial cable. It is important for cable LAN adapter 32 to be screened from noise and hardy enough to work in any environment while remaining inexpensive. Thus, in order to keep costs low and the system robust, the architecture design of adapter 32 uses a digital modulation scheme such as Frequency Shift Keying (FSK) modulation or Binary Phase Shift Keying (BPSK) modulation. Moreover, although data may be transmitted within the coaxial cable continuously, discontinuously, or a combination thereof, modulation is done preferably in a discontinuous, burst fashion to accommodate network type data with minimum receiver setup time. Other acceptable modulation schemes include Quadrature Phase Shift Keying (QPSK) digital modulation.

III. RF & Mixed Signal Section

From Baseband section 90, the data encounters Radio Frequency (RF) and Mixed Signal section 100. The RF & Mixed Signal section consists of a complementary metal-oxide semiconductor (CMOS) RF chip 102, crystal oscillator 104, and crystal oscillator 106. Crystal oscillator 104 and crystal oscillator 106 generate the clock that runs CMOS RF chip 102. As shown in FIG. 4, CMOS RF chip 102 comprises mixed-signal section having digital to analog converter (DAC) 108 and analog to digital converter (ADC) 110, up converter 112 and down converter 114, power amplifier (PA) 116 and a low noise amplifier (LNA) 118, and Low (LO) frequency synthesizer (SYN) timing circuit 120 that couples the converters to their respective amplifiers through mixer 122.

Within DAC 108, the digital data from modulator 96 is converted to an analog signal having an intermediate frequency (IF) of around 44 MHz. To bring the signal operating frequency to the desired transmitting frequency, here 1300 MHz as seen in FIG. 3, the analog signal is processed by up converter 112. Up converter 112 generates a carrier modulated digital signal on which to transmit client data through the coaxial cable network. The power is amplified in PA 116, wherein the signal is then sent to Medium Interface section 130.

IV. Medium Interface Section

In accordance with an embodiment of the invention, Medium Interface section 130 interfaces with cable wire 24 through switch 132 that operates to either transmit or receive signals. A single pole double throw (SPDT) transmission switch would accomplish this. Through switch 132, the signal is transmitted into cable wire 24. Although FIG. 4 shows a one signal frequency design channel, more than one signal frequency may be used.

With the signal transmitted from a first adapter 32, at least a designated second adapter 32 will receive the signal. On receiving the transmitted data through cable wire 24, second adapter 32 reverses the process by converting the transmitted data into a form usable by a second client and transmitting that data to that client. From switch 132 of FIG. 4, LNA 118 focuses the signal so that down converter 114 may convert the signal to an intermediate frequency (IF) of around 44 MHz. The analog signal is then converted to a digital signal in ADC 110.

At this point in the process, filtering may be necessary. As the signal travels within the coaxial cable network, reflection from low pass filter 18 may compensate for signal attenuation due to splitters in the coaxial cable network, but may also cause a reflection mismatch between the signal and the reflected signal. Filters within Baseband section 90 filter out such reflected signals. From there, the signal is demodulated at demodulator 98 with the data then being decoded and corrected at FEC decoder 94. The digital data is then sent to the second client through MAC & Client Interface section 80.

A specific embodiment of the cable LAN according to the invention has been described for the purpose of illustrating the manner in which the invention may be made and used. It should be understood that implementation of other variations and modifications of the invention and its various aspects will be apparent to those skilled in the art, who may develop a variation of structural details without departing from the principles of the present invention. For example, the components of the cable LAN adapter, either individually or in combination, can be housed in an integrated circuit. The cable LAN has been describe in reference to use in a private home, but may be used for any enterprise that has cabling equal to or superior than that found in a typical private home, including a small office/home office (SOHO).

What is claimed is:

1.-26. (canceled)

27. An interface component for communicating between a client device and a local area network (LAN), the interface component comprising:
a universal client interface to communicate a signal between a cable LAN adapter and the client device; and
the cable LAN adapter comprising:
a broadband application specific integrated circuit (ASIC) to encode and to modulate the signal received from the universal client interface and to decode and to demodulate the signal received from a radio frequency and mixed signal, section (RF&MSS);
the RF&MSS to convert the encoded and modulated signal received from the ASIC to a carrier modulated digital signal with a transmission frequency, the transmission frequency greater than a signal cut-off frequency defined for conventional coaxial cable services, and the RF&MSS to convert the carrier modulated digital signal received from a transmission switch to the encoded and modulated signal transmitted to the ASIC; and
the transmission switch to transmit the carrier modulated digital signal through a coaxial cable to at least one other cable LAN adapter and to transmit the carrier modulated digital signal to the RF&MSS.

28. The interface component of claim 27, wherein the universal client interface is a Universal Serial Bus (USB) attachment or an attachment meeting the IEEE 1394 standard.

29. The interface component of claim 27, wherein the universal client interface is integrated into the cable LAN adapter.

30. The interface component of claim 27, wherein the universal client interface is housed in any of a personal computer, a set top box, or the cable LAN adapter.

31. The interface component of claim 27, wherein the universal client interface is coupled to a dongle security system.

32. The interface component of claim 31, wherein the dongle security system is a serialized erasable programmable read-only memory.

33. The interface component of claim 27, wherein the ASIC comprises:
an interface core to communicate with the universal client interface and with a burst controller;
the burst controller to communicate with a baseband section; and
the baseband section to encode and to modulate the signal and to decode and to demodulate the encoded and modulated signal.

34. The interface component of claim 33, wherein the burst controller supports both isochronous and asynchronous data.

35. The interface component of claim 33, wherein the burst controller uses a time division multiple access scheme.

36. The interface component of claim 33, wherein the baseband section comprises:
an encoder coupled to a modulator, the encoder to receive the signal from the burst controller and to encode the signal;
the modulator coupled to the RF&MSS, the modulator to modulate the encoded signal and to send the encoded and modulated signal to the RF&MSS;
a demodulator coupled to a decoder, the demodulator to receive the encoded and modulated signal from the RF&MSS and to demodulate the encoded and modulated signal; and
the decoder coupled to the burst controller, the decoder to decode the encoded signal and to send the signal to the burst controller.

37. The interface component of claim 36, wherein the encoder is a Forward Error Correction (FEC) encoder.

38. The interface component of claim 37, wherein the FEC encoder is a Reed-Solomon Error Correction Code encoder.

39. The interface component of claim 36, wherein the decoder is a Forward Error Correction (FEC) decoder.

40. The interface component of claim 39, wherein the FEC decoder is a Reed-Solomon Error Correction Code decoder.

41. The interface component of claim 36, wherein the modulator and the demodulator modulate in a discontinuous, burst fashion.

42. The interface component of claim 36, wherein the modulator and the demodulator modulate using a Frequency Shift Keying digital modulation scheme.

43. The interface component of claim 36, wherein the modulator and the demodulator modulate using a Binary Phase Shift Keying digital modulation scheme.

44. The interface component of claim 36, wherein the modulator and the demodulator modulate using a Quadrature Phase Shift Keying digital modulation scheme.

45. The interface component of claim 27, wherein the RF&MSS comprises a complementary metal-oxide semiconductor (CMOS) radio frequency (RF) chip.

46. The interface component of claim 45, wherein the CMOS RF chip comprises:
a digital to analog converter (DAC) to receive the encoded and modulated signal from the ASIC and to convert the encoded and modulated signal to an analog waveform with an intermediate frequency;
an up converter coupled to the DAC, the up converter to convert the analog waveform to the carrier modulated digital signal;
a first mixer coupled to the up converter and to a power amplifier, the power amplifier to amplify the carrier modulated digital signal received from the up converter and to send the carrier modulated digital signal to the transmission switch;
a low noise amplifier (LNA) to receive the carrier modulated digital signal from the transmission switch;
a second mixer coupled to the LNA;
a down converter coupled to the second mixer, the down converter to convert the carrier modulated digital signal to the analog waveform; and
an analog to digital converter (ADC) coupled to the down converter, the ADC to convert the analog waveform to the encoded and modulated signal and to send the encoded and modulated signal to the ASIC.

47. The interface component of claim 27, wherein the transmission frequency is greater than 450 MHz.

48. The interface component of claim 47, wherein the transmission frequency is greater than 950 MHz.

49. The interface component of claim 48, wherein the transmission frequency is 1300 MHz.

50. The interface component of claim 27, wherein the transmission switch is a single pole double throw transmission switch.

51. A method for transmitting information from a client device to a local area network (LAN), the method comprising:
communicating a signal from the client device to a cable LAN adapter with a universal client interface;
encoding the signal in the cable LAN adapter;
modulating the encoded signal in the cable LAN adapter;
converting the encoded and modulated signal to a carrier modulated digital signal in the cable LAN adapter, the carrier modulated digital signal having a transmission frequency, the transmission frequency greater than a signal cut-off frequency defined for conventional coaxial cable services; and
transmitting the carrier modulated digital signal through a coaxial cable to at least one other cable LAN adapter.

52. The method of claim 51, wherein the universal client interface is a Universal Serial Bus (USB) attachment or an attachment meeting the IEEE 1394 standard.

53. The method of claim 51, wherein the universal client interface is integrated into the cable LAN adapter.

54. The method of claim 51, wherein the universal client interface is housed in any of a personal computer, a set top box, or the cable LAN adapter.

55. The method of claim 51, wherein the universal client interface is coupled to a dongle security system.

56. The method of claim 55, wherein the dongle security system is a serialized erasable programmable read-only memory.

57. The method of claim 51, wherein the encoded and modulated signal supports both isochronous and asynchronous data.

58. The method of claim 51, wherein the encoded and modulated signal uses a time division multiple access scheme.

59. The method of claim 51, wherein the transmission frequency is greater than 450 MHz.

60. The method of claim 59, wherein the transmission frequency is greater than 950 MHz.

61. The method of claim 60, wherein the transmission frequency is 1300 MHz.

62. The method of claim 51, wherein encoding the signal uses a Forward Error Correction (FEC) encoder.

63. The method of claim 62, wherein the FEC encoder is a Reed-Solomon Error Correction Code encoder.

64. The method of claim 51, wherein modulating the encoded signal is performed in a discontinuous, burst fashion.

65. The method of claim 51, wherein modulating the encoded signal uses a Frequency Shift Keying digital modulation scheme.

66. The method of claim 51, wherein modulating the encoded signal uses a Binary Phase Shift Keying digital modulation scheme.

67. The method of claim 51, wherein modulating the encoded signal uses a Quadrature Phase Shift Keying digital modulation scheme.

68. An apparatus for transmitting information from a client device to a local area network (LAN), the apparatus comprising:
a universal client interface communicating a signal from the client device to a cable LAN apparatus; and
the cable LAN apparatus comprising:
an encoding means for encoding the signal, the encoding means converting the signal to an encoded signal;
a modulating means for modulating the encoded signal, the modulating means converting the signal to an encoded and modulated signal;
a converting means for converting the encoded and modulated signal to a carrier modulated digital signal having a transmission frequency, the transmission frequency greater than a signal cut-off frequency defined for conventional coaxial cable services; and
a transmitting means for transmitting the carrier modulated digital signal through a coaxial cable to at least one other cable LAN apparatus.

69. The method of claim 68, wherein the universal client interface is a Universal Serial Bus (USB) attachment or an attachment meeting the IEEE 1394 standard.

70. The apparatus of claim 68, wherein the universal client interface is integrated into the cable LAN adapter.

71. The apparatus of claim 68, wherein the universal client interface is housed in any of a personal computer, a set top box, or the cable LAN adapter.

72. The apparatus of claim 68, wherein the universal client interface is coupled to a dongle security system.

73. The apparatus of claim 72, wherein the dongle security system is a serialized erasable programmable read-only memory.

74. The apparatus of claim 68, wherein the encoding means supports both isochronous and asynchronous data.

75. The apparatus of claim 68, wherein the encoding means uses a time division multiple access scheme.

76. The apparatus of claim 68, wherein the transmission frequency is greater than 450 MHz.

77. The apparatus of claim 76, wherein the transmission frequency is greater than 950 MHz.

78. The apparatus of claim 77, wherein the transmission frequency is 1300 MHz.

79. The apparatus of claim 68, wherein the encoding means uses a Forward Error Correction (FEC) encoder.

80. The apparatus of claim 79, wherein the FEC encoder is a Reed-Solomon Error Correction Code encoder.

81. The apparatus of claim 68, wherein the modulating means is performed in a discontinuous, burst fashion.

82. The apparatus of claim 68, wherein the modulating means uses a Frequency Shift Keying digital modulation scheme.

83. The apparatus of claim 68, wherein the modulating means uses a Binary Phase Shift Keying digital modulation scheme.

84. The apparatus of claim 68, wherein the modulating means uses a Quadrature Phase Shift Keying digital modulation scheme.
